(19) United States
(12) Patent Application Publication
(10) Pub. No.: US 2006/0063873 A1
(43) Pub. Date: Mar. 23, 2006

(54) Nano water paint having nano particles surfaced with self-assembly monolayers

(76) Inventors: Ching-Bin Lin, Taipei (TW); Shaing-Hai Yeh, Hsin-Ten (TW); Wen-Chin Liu, Tainan (TW); Hung-Chou Lee, Chung-Ho (TW)

Correspondence Address: Ching-Bin Lin, P.O. Box 55-846, Taipei, 104, TW

(21) Appl. No.: 10/942,512

(22) Filed: Sep. 17, 2004

(51) Int. Cl. C08K 3/22; C08K 3/34

(52) U.S. Cl. 524/430; 524/492

(57) ABSTRACT

A process for preparing nano water paint comprising the steps of: A. Modifying the chemical property on the surface of nano particles by hydroxylation for forming hydroxyl groups at high density on the surface of the nano particles; B. Forming self-assembly monolayers of low surface energy compounds on the nano particles by substituting the self-assembly monolayers for the hydroxyl groups on the nano particles for disintegrating the clusters of nano particles and for forming the self-assembly monolayers homogeneously on the surface of the nano particles; and C. Blending or mixing the nano particles having self-assembly monolayers formed thereon with organic paint to form nano water paint.

### BACKGROUND OF THE INVENTION

The conventional nano water paint contains nano particles which are thermodynamically unstable, hydrophilic and strongly polar; thereby being difficult to be homogeneously dispersed in an organic paint as shown in FIG. 1 (a SEM electronic microscopic view) in which the nano particles cluster in the coating film of the nano paint and are therefore unhomogeneously dispersed in the paint.

The conventional nano water paint has the following drawbacks:
1. Whenever flushing the coating area wherein the nano particles cluster, the coating film will be easily peeled. The coating film without containing nano particles therein will weaken its resistance to visco-elastic deformation to thereby decrease the hardness and brushing or washing durability of the coating film.
2. The organic coating film has a high surface energy with the nano particles unhomogeneously distributed in the coating film, thereby exerting poor lotus effect. In the coating film area wherein no nano particle is presented, a corrugated surface is not formed and the dirts or liquid drops will be easily moistened and accumulated on such a surface. As shown in FIG. 2, a small contact angle (acute angle) is formed between a water drop and the coating surface. Due to such a small contact angle, the water drop (not formed as a spherical shape) will not be easily rolled to carry and remove the dirts accumulated on the surface. Therefore, it has a poor anti-fouling or self-cleaning property.

Meanwhile, the small contact angle between the water drop and the coating surface will increase the mass transfer between moisture and coating film to thereby cause a poor water repellency of the paint or to facilitate a moisture penetration into the coating layer.
3. Since the nano particles are not homogeneously distributed in the coating film, the coating area wherein no nano particle is presented may be easily attacked by ultraviolet (UV) light, easily causing UV-oxygen degradation or thermal-oxygen degradation for breaking the molecular chain of the organic paint and thereby deteriorating the weather resistance, anti-aging property and other physical or chemical properties of a paint.

The present inventor has found the drawbacks of the conventional nano water paint and invented the present process for making a nano water paint with improved properties.

### SUMMARY OF THE INVENTION

The object of the present invention is to provide a process for preparing nano water paint including the steps of:
A. Modifying the chemical property on the surface of nano particles by hydroxylation for forming hydroxyl groups at high density on the surface of the nano particles;
B. Forming self-assembly monolayers of low surface energy compound on the nano particles by substituting the self-assembly monolayers for the hydroxyl groups on the nano particles for disintegrating the clusters of nano particles and for forming the self-assembly monolayers homogeneously on the surface of the nano particles; and
C. Blending or mixing the nano particles having self-assembly monolayers formed thereon with organic paint to form nano water paint.

Accordingly, the object of the present invention is to provide a nano water paint with improved or enhanced paint properties including: self-cleaning, anti-fouling, anti-fungal, anti-algal, water repellency, flushing and brushing durability, weather resistance and anti-aging properties.

### BRIEF DESCRIPTION OF THE DRAWINGS

FIG. 1 is a microscopic illustration of conventional nano water paint showing the unhomogeneous distribution of nano particles, namely in clusters, in the nano coating film.

FIG. 2 shows a small contact angle between a water drop and a nano coating film of the conventional nano water paint.

FIG. 3 is a microscopic illustration showing the homogeneous distribution of nano particles in the coating film of the present invention, which is obtained by SEM, Mag=100.00 KX, WD=5 mm, EHT=2.00 kV, and the scale unit (d) indicating 200 nm.

FIG. 4 shows a large contact angle between a spherical water drop and the nano coating film of the present invention.

### DETAILED DESCRIPTION

The process for preparing the nano water paint of the present invention will be described hereinafter.

The nano particles for effectively shielding ultra-violet lights in different wave length may include SiOx, TiO₂, ZnO and Fe₂O₃ to be used in the present invention.

The silicon oxide (SiOx) is especially recommended in the present invention. The silicon oxide has strong surface activity, once added into the organic paint and homogeneously dispersed in the organic paint, easily bonding with the oxygen in the molecular chain of the organic paint to thereby bond the nano particles with the organic paint. Also, the silicon oxide has a high reflection rate (up to 85%) for reflecting ultra-violet light with medium wave length.

Besides, other nano particles such as titanium oxide (TiO₂), Zinc oxide (ZnO) and ferric oxide (Fe₂O₃) are capable of shielding UV lights and may also be used in the present invention accordingly.

The nano particles are then modified as below-mentioned:

The surface of nano particles (e.g. SiOx) is subjected to hydroxylation in order to form hydroxyl groups in high density on the surface of nano particles. The nano particles after being densely bonded with hydroxyl groups are placed in a closed container and a self-assembly monolayer compound (e.g. silane) having low surface energy is passed into the container for performing a gas-phase reaction in the container for replacing the hydroxyl groups on the nano particles by the self-assembly monolayers for effectively disintegrating the clusters of nano particles and for homogeneously forming the self-assembly monolayers on the surface of the nano particles for a primary modification of the nano particles.

The silicon oxide (SiOx) may be reacted with tridecafluoro-1,1,2,2-tetrahydrooctyl trichlorosilane (F₁₃-TCS) for forming the self-assembly monolayer of silane on the silicon oxide as shown in the following formula:

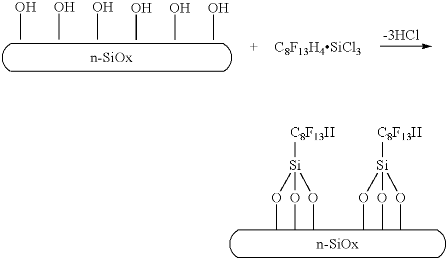

The hydrogen on the hydroxyl group of the silicon oxide will react with the chlorine on the silane (to conduct a substitution reaction) to thereby substute the self-assembly monolayer of silane for the hydroxy group of the silicon oxide. The hydrogen chloride as reacted from hydrogen and chlorine is then removed from the above-mentioned substitution reaction.

The neighboring self-assembly monolayers as respectively formed on the surfaces of any neighboring silicon oxide molecules will produce repulsive force therebetween. Such a repulsive force will disintegrate the silicon oxide molecules without forming clusters or agglomeration. The nano particles surfaced with self-assembly monolayers are then blended with organic paint. Or, the nano particles (with self-assembly monolayers) are homogeneously dispersed in the monomer of organic paint. The organic paint monomer having nano particles dispersed therein is then polymerized to form a nano water paint.

The self-assembly monolayer compounds or materials of the present invention may be selected from the following silanes:
Tridecafluoro-1,1,2,2-tetrahydrooctyl trichlorosilane, (F13-TCS);
Octadecyltrichlorosilane, (OTS);
Alkylchlorosilanes;
Propyltrichlorosilane, (PTCS);
3,3,3-trifluoropropyl trichlorosilane, (FPTCS);
Dimethyldichlorosilane, (DDMS);
Heptadecafluoro-1,1,2,2-tetrahydrodecyltrichlorosilane, (FDTS); and
other silanes.

Typical examples for making and testing the nano paint of the present invention are described in detail as follows:

### EXAMPLE 1

Nano particles of silicon oxide (SiOx, x=1.2˜1.6) having a specific area of 60 m²/g, particle size 80±10 nm are added into aqueous solution of H₂O₂ (20%) to perform hydroxylation on the SiOx.

The nano particles, after hydroxylation, are dried. By applying FTIR (quantitative integration) to obtain the hydroxyl content on the nano particles, the hydroxyl groups may reach up to 5×10¹⁴ OH group s/cm².

Quantitative liquid silane is then capillarily fed to impregnate the dried clustering nano particles, which are then placed in a closed Petri dish having a hot plate fixed under the Petri dish. The closed dish is then purged and filled with nitrogen gas to be free of moisture in the dish. The temperature of the hot plate may be adjusted to 250° C. to be higher than the melting point of the silane (F₁₃-TCS). The silane is heated to be at gaseous state to perform the substitution reaction for 2 hours to remove HCl to form the self-assembly monolayers of the silane on the surface of the nano particles of SiOx. Anhydrous hexane is applied to wash and remove the excess silane in the SiOx. The SiOx is now formed with self-assembly monolayers (or the silane molecular layers) having low surface energy on the surface of SiOx.

The nano particles of SiOx surfaced with the self-assembly monolayers as above-mentioned are homogeneously blended with an organic paint (water soluble) in an aqueous solution to obtain a nano water paint.

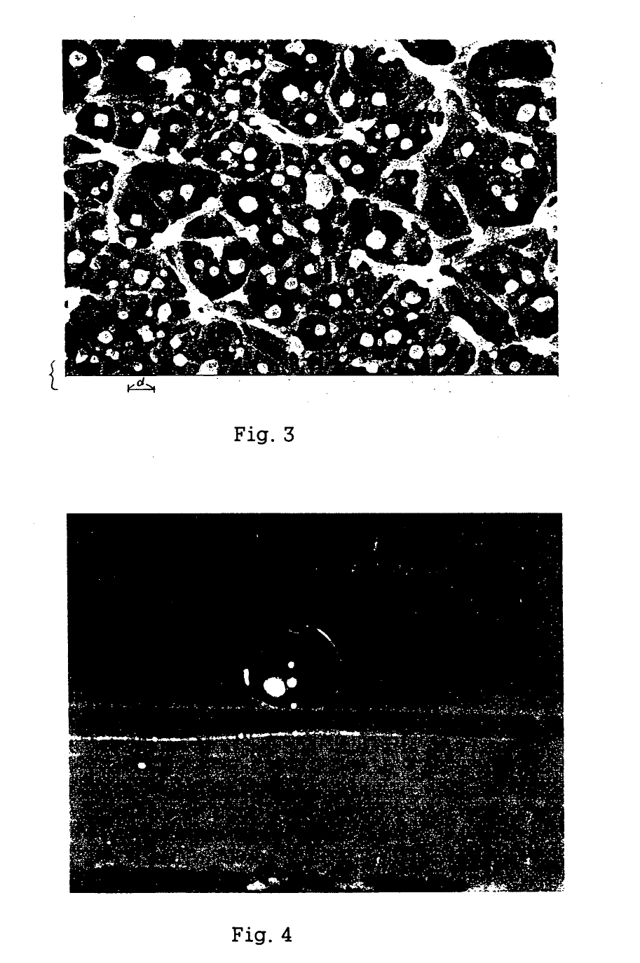

The nano particles having self-assembly monolayers of silane formed on the surface of the nano particles will produce repulsive force (of static electricity) between the neighboring particles to prevent from clustering of the nano particles in the water paint. The nano particles, under the shear agitation and blending, will be homogeneously dispersed in the organic paint as shown in FIG. 3, which shows a homogeneous distribution of the nano particles better than that as shown in the prior art as shown in FIG. 1.

On the point of view of energy factor, the molecular layers of the self-assembly monolayers (silane) or the molecular chains of the organic paint are presented at low energy state during the agitation to be easily entangled between the silane monolayers and the paint molecular chains to thereby be stably mechanically locked. In other words, the organic paint and the nano particles surfaced with the self-assembly nonolayers will be stably homogeneously blended to enhance the paint quality for its end use.

The nano particles surfaced with the self-assembly monolayers may also be homogeneously dispersed in monomer of water-soluble organic paint which is then polymerized to homogeneously distribute the nano particles in the “matrix” of organic paint to obtain the nano water paint.

### EXAMPLE 2

A nano water paint composition is prepared to have the following ingredients.

| | | Percentage |
|---|---|---|
| | Ingredients | by weight (%) |
| 1. | Water | 9.27 |
| 2. | Acrylic copolymerication emulsion | 57.53 |
| 3. | Nano particles of SiOx surfaced with F13-TCS | 9.80 |
| | silane (average particle size, 80 ± 10 nm) | |
| 4. | Talc | 7.21 |
| 5. | Dispersing agent | 1.81 |
| 6. | Butyl cellosolve solvent | 7.82 |
| 7. | Carbitol solvent | 0.42 |
| 8. | Dibutyl phathalate | 1.31 |
| 9. | Ammonium Perchromate | 0.48 |
| | (10% aqueous solution) | |
| 10. | Ammonium hydroxide | 0.33 |
| | (28% aqueous solution) | |
| 11. | Defoaming agent | 0.26 |
| 12. | Polyethylene wax | 0.62 |
| 13. | Surface active agent | 0.28 |
| 14. | Corrosion inhibiting agent | 2.86 |
| | | 100% |

The paint composition thus prepared has shown the following properties:

| | |
|---|---|
| PH | 7.0˜8.0 |
| Viscosity | 100˜2000 mpa · s |
| Appearance | milky color |
| | Residual monomer content ≦ 0.5% |
| Dilution stability | without formation of separated layers |

The obtained nano water paint is coated on a substrate (such as concrete or steel). When subjected to vaporization of moisture in the paint and under UV light radiation, the molecular chains of the nano particles surfaced with self-assembly monolayers will be bonded to form crosslinking between the molecular chains due to photo-oxygen degration. The nano particles surfaced with self-assembly monolayers will be tightly tangled or bonded with the molecular chains of organic paint to homogeneously distribute the nano particles in the coating film to form a dense low surface energy coating film of the nano paint to greatly improve the coating properties of the nano paint.

The testing result of the nano paint of this invention as coated on a concrete substrate is shown as follows:

| Properties | Testing result |
|---|---|
| Flushing (washing) durability | ≧6000 flushing times, |
| | no abnormal result found |
| Hardness (pencil hardness) | 3H |
| Pulverization degree | 0 |
| Anti-fouling | 6% |
| Cooling/heating recycling | no swelling, no breaking |
| (repeated for 3 cycles | and no peeling |
| from −20° C. to 80° C. ) | |
| Adhesion strength | 8.3 kgf/cm (standard state); |
| | 6.7 kgf/cm (after water soaking) |
| Water durability | no foaming, no color change and |
| | no peeling after 120 hours of |
| | water durability test |
| Water penetration | 0.4 ml |
| Anti-aging property | 0.7 (color fading value after 168 |
| | hours aging test) |
| Acid resistance (3% H₂SO₄) | No swelling, no breaking, and no |
| | peeling after soaking of 48 |
| | hours |
| Base resistance (3% NaOH) | No swelling, no breaking and no |
| | peeling after soaking of 48 |
| | hours |
| Covering area per liter | 12 m²/l |
| Adhesion strength between | 10 |
| coating film and concrete | |
| Contact angle | 142 degrees |

(Note:
The test is according to related ASTM methods)

From the above results, it is found that the present invention provides a nano paint having strong physical and water properties.

The composition of the present invention may be prepared as a basic paint including an emulsion, a suspension or a gel which is water soluble or hydrophilic. Any conventional methods for mixing solvents, pigments or additives of the paints or coating compositions; or any application methods for coating the paints on any substrates may be used in the present invention, which are not limited.

Conclusively, the present invention provides a better nano water paint having the following advantages than the conventional water paint.

1. Increased Hardness and Flushing (Washing) Durability of Coating Film:

Since the nano particles having high hardness are homogeneously dispersed in the coating film, and the entanglement and bonding between the nano particles and the organic molecular chains of the paint will resist the visco-elastic deformation of the coating film to thereby increase the hardness and flushing (washing) durability of the nano paint.
   2. Increased Water Repellency and the Related Hygienic Properties:

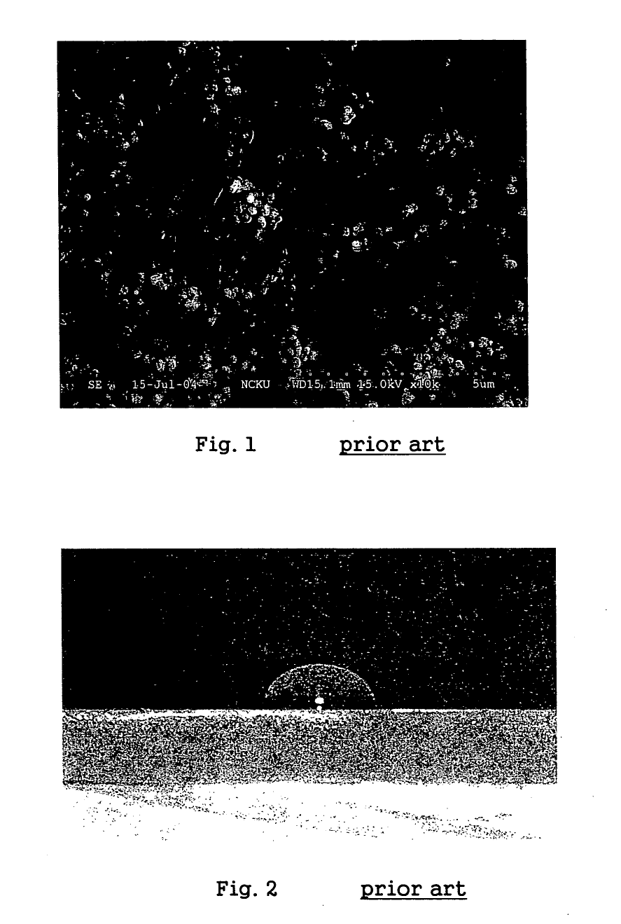

As shown in FIG. 4, a contact angle between a circular-shaped water drop and the coating film of the present invention is greater than a small contact angle of a conventional paint (FIG. 2). Such a greater contact angle (about 142 degrees) will decrease the mass transfer of moisture from the water drop into the coating layer, thereby enhancing the water repellence of the present invention.
By the way, the coating film as effected by the present invention will also increase its anti-fouling, self-cleaning, anti-fungal, anti-algal, and easy-flushing properties.
   3. Prevention of Moisture Penetration:

Since the nano particles are homogeneously dispersed in the coating film to evenly occupy the free volume in the coating film, the penetration of moisture into the coating layer will then be precluded or minimized. The self-assembly monolayers on the surface of SiOx particles are non-polar and are immiscible with water (which is polar). The solubility parameter of the nano coating film of the present invention is greatly different from that of water. So, the coating film of the present invention will prevent from moisture penetration thereinto.

4. Better Applicability Including Increased Weather Resistance, Covering Area and Suspension Stability:

The nano particles are homogeneously dispersed in the coating film to well reflect the ultra-violet lights to reduce the photo-oxygen degradation or thermal-oxygen degradation to thereby increase its weather resistance, anti-aging property and ornamentality.

The nano particles are evenly distributed in the coating matrix to enhance its rheology to thereby increase its covering area per unit volume. In other words, the paint consumption can be saved economically.

The clusters of nano particles have been prevented due to the mutual repulsion of static electricity among the particles, thereby preventing settling of the agglomerated particles and maintaining a stable suspension of the coating composition for ensuring a better paint quality.

The present invention may be modified without departing from spirit and scope of the present invention.

I claim:

1. A process for preparing nano water paint comprising the steps of:
A. Modifying the surface of nano particles of metal oxides by forming a plurality of hydroxyl groups on the metal oxides by hydroxylation;
B. Substituting self-assembly monolayers of low surface energy compound for the hydroxyl groups formed on the surface of the nano particles of metal oxides to homogeneously form self-assembly monolayers on the surface of the nano particles; and
C. Homogeneously adding the nano particles formed with the self-assembly monolayers thereon into a water-soluble organic paint to obtain a nano water paint.

2. A process according to claim 1, wherein said metal oxides are selected from the group consisting of: silicon oxide, titanium oxide, zinc oxide and ferric oxide.

3. A process according to claim 1, wherein the step to homogeneously form self-assembly monolayers on the nano particles is conducted in a closed container by charging the self-assembly monolayers and the nano particles into the closed containers for performing substitution reaction by substituting the self-assembly monolayers for the hydroxyl groups on the surface of nano particles of metal oxides.

4. A process according to claim 1, wherein said self-assembly monolayers of low surface energy compounds are silanes.

5. A process according to claim 1, wherein the adding of nano particles into organic paint is operated by blending the nano particles having the self-assembly monolayers formed thereon with the organic paint in an aqueous solution for obtaining the nano water paint.

6. A process according to claim 1, wherein the adding of nano particles into organic paint is conducted by homogeneously dispersing the nano particles having the self-assembly monolayers formed thereon into a monomer of the organic paint; said monomer of the organic paint having the nano particles dispersed therein being polymerized to form the nano water paint.

7. A nano water paint prepared by a process as set forth in claim 1.
